(19) United States
(12) Patent Application Publication
(10) Pub. No.: US 2022/0005089 A1
(43) Pub. Date: Jan. 6, 2022

(54) PROPERTY MANAGEMENT PRICING SYSTEM AND METHOD

(71) Applicant: Daniel SHAKED, Los Atos, CA (US)

(72) Inventor: Daniel SHAKED, Los Atos, CA (US)

(21) Appl. No.: 17/096,552

(22) Filed: Nov. 12, 2020

Related U.S. Application Data
(60) Provisional application No. 63/047,102, filed on Jul. 1, 2020.

(51) Int. Cl. G06Q 30/02; G06Q 50/16; G06K 9/62; G06N 5/00; G06N 3/04

(52) U.S. Cl. CPC G06Q 30/0283; G06Q 50/163; G06N 3/049; G06K 9/6293; G06N 5/003; G06K 9/6276

(57) ABSTRACT

Provided herein are systems, methods and computer media for automatically providing property-specific pricing for property management services. In one exemplary implementation, a method includes gathering data, cleansing and transforming the data, storing the data for analysis and inputting the stored data into a modeling and training process. The modeling and training process arrives at a preliminary price for providing property management services for a specific property. The exemplary method further includes testing the preliminary price to arrive at a final vetted price for providing property management services for the specific property.

### CROSS REFERENCE TO RELATED APPLICATIONS

This application claims the benefit of U.S. Provisional Application No. 63/047,102, filed Jul. 1, 2020, which is herein incorporated by reference in its entirety.

### INCORPORATION BY REFERENCE

All publications and patent applications mentioned in this specification are incorporated herein by reference in their entirety to the same extent as if each individual publication or patent application was specifically and individually indicated to be incorporated by reference.

### BACKGROUND

When property owners rent out their properties to tenants, they may choose to manage the rental property themselves with or without the help of an employee, or they may engage a property management company. Property management companies typically deal directly with prospects and tenants, collect rent, handle maintenance and repair issues, respond to tenant complaints, pursue evictions, etc. Property management companies typically charge a monthly or annual fee for their services, which may be a fixed percentage of the rent being collected from the tenants. These fixed fees tend to be the same across multiple properties that receive the same amount of rent. The regular periodic fees may not include all of the above services. For example, when a tenant leaves and advertising and interviewing must be done to secure a new tenant, or when repairs need to be made to the property, additional fees typically are charged by the property management company for these activities.

A significant portion of the rental income generated by a property can end up going to a property management company, particularly in times when there is tenant turnover and or maintenance and repair work being done. Additional income is lost if the property remains vacant for an extended period of time.

Accordingly, what is needed and is not provided by the prior art are improved systems and methods for allowing property owners to keep more of the rental income from their properties and for allowing the amount of rental income to be more predictable over time. Such improved systems and methods should also allow a property management company to make a fair and predictable profit from each of the properties they manage. The innovations described herein solve these unmet needs and provide additional advantages.

### SUMMARY

According to aspects of the present disclosure, a method of automatically providing property-specific pricing for property management services may include gathering data, cleansing and transforming the data, storing the data for analysis, inputting the stored data into a modeling and training process to arrive at a preliminary price for providing property management services for a specific property, and testing the preliminary price to arrive at a final vetted price for providing property management services for the specific property.

In some embodiments, the gathered data includes multiple parameters gathered from at least four different data types. The at least four different data types may include property, maintenance, tenant and location. In some embodiments, at least one of the parameters is gathered from each of the at least four different data types. In some embodiments, at least three of the parameters are gathered from each of the at least four different data types. In some embodiments, at least five of the parameters are gathered from each of the at least four different data types.

In some embodiments, the gathered data includes data received from a plurality of smart sensors. At least one of the smart sensors may be located on the specific property. In some embodiments, the modeling and training process includes multiple iterations of designing, training and evaluating a model. The modeling and training process may include training a machine learning model. In some embodiments, the machine learning model includes a random forest supervised learning algorithm a long short-term memory recurrent network, a k-nearest neighbors algorithm and or a logistic regression algorithm.

In some embodiments, the modeling and training process includes training a model with a plurality of machine learning models that each have an assigned weight. In these embodiments, the assigned weights determine the associated model's relative influence on the preliminary price. The assigned weight for each machine learning model may be based on previous performance of the associated model.

In some embodiments, the testing step includes running a model developed during the modeling and training process with new data that was not used to train the model. During the modeling and training process a required profit rate for a property management company may be considered.

According to aspects of the present disclosure, a non-transitory computing device readable medium is provided. The non-transitory computing device readable medium has instructions stored thereon for automatically providing property-specific pricing for property management services. The instructions are executable by a processor to cause a computing device to gather data in the computing device, cleanse and transform the data in the computing device, store the data, in the computing device, for analysis. The instructions are further executable to cause the computing device to input the stored data into a modeling and training process, in the computing device, to arrive at a preliminary price for providing property management services for a specific property. The instructions are further executable to cause the computing device to test, in the computing device, the preliminary price to arrive at a final vetted price for providing property management services for the specific property.

### BRIEF DESCRIPTION OF THE DRAWINGS

The novel features of the disclosure are set forth with particularity in the claims that follow. A better understanding of the features and advantages of the present disclosure will be obtained by reference to the following detailed description that sets forth illustrative embodiments, in which the principles of the disclosure are utilized, and the accompanying drawings of which:

FIG. 1A is a diagram showing an example distribution of property rental income when traditional property management services are utilized.

FIG. 1B is a diagram showing an example distribution of property rental income when improved property management services are utilized according to aspects of the present disclosure.

FIG. 2 is a chart showing various parameters and types of data that may be used as inputs to an exemplary price-predicting model according to aspects of the disclosure.

FIG. 3 is a flowchart showing an exemplary process for predicting an appropriate property management flat fee according to aspects of the disclosure.

FIGS. 4A-4D together form a flowchart showing further details of the exemplary process of FIG. 3.

### DETAILED DESCRIPTION

Described herein are apparatuses (e.g., systems, computing device readable media, devices, etc.) and methods for improved property management that benefit both a property owner and a property management company. The innovative platform changes the way property management services are provided, such as to owners of single family homes and small multi-family homes. In some embodiments, this is accomplished by providing optimal flat rate pricing for all-inclusive property management services based on many factors associated with a specific property.

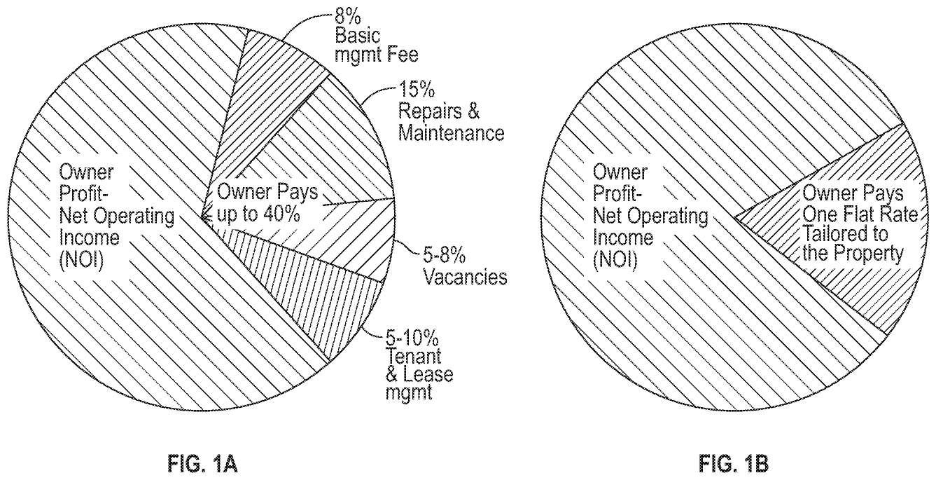

Referring to FIG. 1A, a pie chart shows the breakdown on how rental income from a property is typically distributed with a traditional property management service. In this example, 8% of the rental income is paid to a property management company. Another 15% can go to repairs and maintenance. These expenses can vary widely and can be very unpredictable. Over time, another 5-8% can go to vacancies when one tenant leaves and before the next tenant starts paying rent. Tenant and lease management can take away another 5-10%. This leaves 59-67% net operating income (NOI) for the property owner.

In another example of a property managed with a traditional property management service, the annual rental income is $20,000. From this income, a property management company receives $2,000 for managing the property. Another $2,000 goes to maintenance, and another $2,000 is spent on unexpected repairs. A simple vacancy can cause the property owner to lose $1,600 in a one-month vacancy, $2,000 in turnover repairs, $200 for listing fees, $200 for advertising and $750 for leasing fees. This leaves the property owner with $9,250, or 46% of the rental income for that particular year.

Referring to FIG. 1B, the rental income distribution from a property managed according to aspects of the present disclosure is shown. By comparing FIG. 1B to FIG. 1A, it can be seen that the property management company receives more than double the amount received in the example of FIG. 1A. However, it can also be seen that the property owner earns a significantly higher net operating income in the example of FIG. 1B. This is because in this example the property management company assumes all of the costs of managing the property, preventative maintenance, repairs, vacancies, and tenant and lease management. Whenever the property is vacant or rent is otherwise not being paid, the management company pays the rent that is not being collected from a tenant. The property owner is charged one flat rate that is tailored to the specific property being managed and maintained. According to aspects of the present disclosure, systems and methods are disclosed herein for determining what the flat rate should be for each property.

The unique property management service disclosed herein ensures property owners that the payments they will make on their property over time will remain constant and predictable. It also ensures that the income that the owners will receive from their property will remain constant and predictable. Moreover, the service will typically provide a net operating income that is higher than if managed in a traditional manner. In some embodiments, this service is similar to insurance service in that it ensures a constant income and profit to the property owner each month/year. This occurs even during times when expenses for the property and/or vacancies are high. By using the fee pricing model disclosed herein, property management companies can also benefit by improving their portfolio, profit and growth potential.

In some embodiments of the inventive fee pricing model used to set a flat rate for the exemplary property management service described above, many parameters associated with a specific property are used. These parameters may originate from data kept internally by a property management company, external to the company, or both. In some embodiments, this data is adaptive to changes that may occur over time. In some embodiments, the prediction of the appropriate monthly price the property owner will pay the management company focuses on the risks and tasks that need to be taken in order to minimize the maintenance costs for the property. Pricing data should be accurate in a way that maximizes the management company profit on one hand, and is competitive and profitable for the property owners on the other hand. In some embodiments, the optimal net operation income is achieved by accurately predicting the operational and maintenance costs of a particular property, and or determining the right type of tenant to occupy the property.

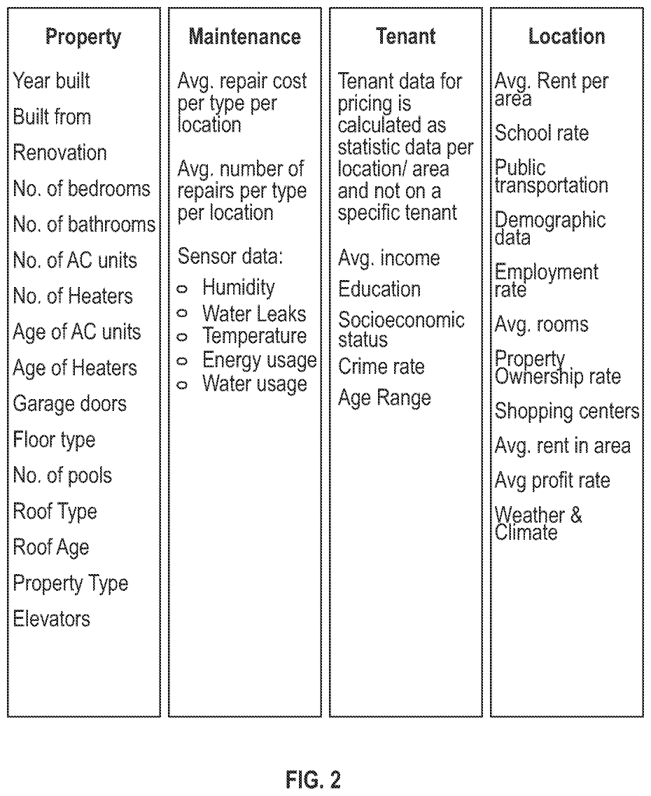

Referring to FIG. 2, an exemplary fee pricing model is disclosed that considers inputs taken from the four types of data depicted in the figure. In this example, the four main data types (or sources) are Property, Maintenance, Tenant and Location. Under each data type, various different parameters (or features) are shown. In this exemplary embodiment, at least one parameter is used from each of the four types. In some embodiments, at least three, at least five or at least ten parameters are used from a data type. In other embodiments, more or fewer data types are used, and or more or fewer parameters are used as inputs to the fee pricing model.

Under the Property data type in FIG. 2, “Built from” refers to the primary materials and or secondary materials used. For example, the property may be built from brick, stone, stucco, wood siding, etc. “Renovation” refers to the year, type and or square footage, etc. of any renovations performed since the property was originally constructed. “Property Type” refers to whether the property is a single family home, a small multi-family home, etc.

Under the Maintenance data type in FIG. 2, “Avg. repair cost per type per location” refers to the average cost for a repair of a particular type, such as a kitchen plumbing repair, a bathroom plumbing repair, an outdoor plumbing repair, a roof leak, a furnace repair, etc. “Per location” refers to the region around the specific property that has similar repair costs. The region could be a neighborhood, a section of town, a city, a county, a state or other geographically relevant region. “Avg. number of repairs per type per location” refers to how many repairs of a particular type typically need to be made per time period (such as a year) in the region around the property. The above data can come from external sources such as property management associations, repair organizations or other sources. Alternatively or in addition to external sources, the data can come from internal sources such as databases and models developed by a property management company. In some situations, smart sensors can be employed on the specific property being modeled and or on other properties in the area. The sensors can monitor parameters such as humidity, water leaks, temperature (of the living space, attic space, crawl space, HVAC unit, hot water heater, etc.), energy usage, water usage and or other parameters. In some implementations, the sensors are wired or communicate wirelessly with a central hub located on the property. The hub collects data from the sensors and then sends the data to a server that monitors multiple properties and communicates with a central database. Just the fact that particular sensors will be used, such as to predict improved preventative maintenance intervals and or early detection of failures, can affect the pricing model. In other situations, the ranges of data from the sensors are used to help formulate the fee model. The use of these sensors can often greatly reduce maintenance and or repair costs, thereby providing greater profits that can be allocated between the property owner and management company.

Under the Tenant data type in FIG. 2, the various parameters used for determining pricing in this embodiment are average statistical data per location or area rather than data on any specific tenant. Average credit score and or range of credit scores of tenants in the area may also be considered.

Under the Location data type in FIG. 2, the listed parameters each relate to a relevant geographic region around the subject property, such as the city in which the property is located. Number of, type and or proximity to universities, parks, public transportation, shopping centers, etc. may also be considered. “Avg. profit rate refers to the average profit made on all or similar properties in the area. Local labor rates, average home value, range of home values and other parameters may also be considered.

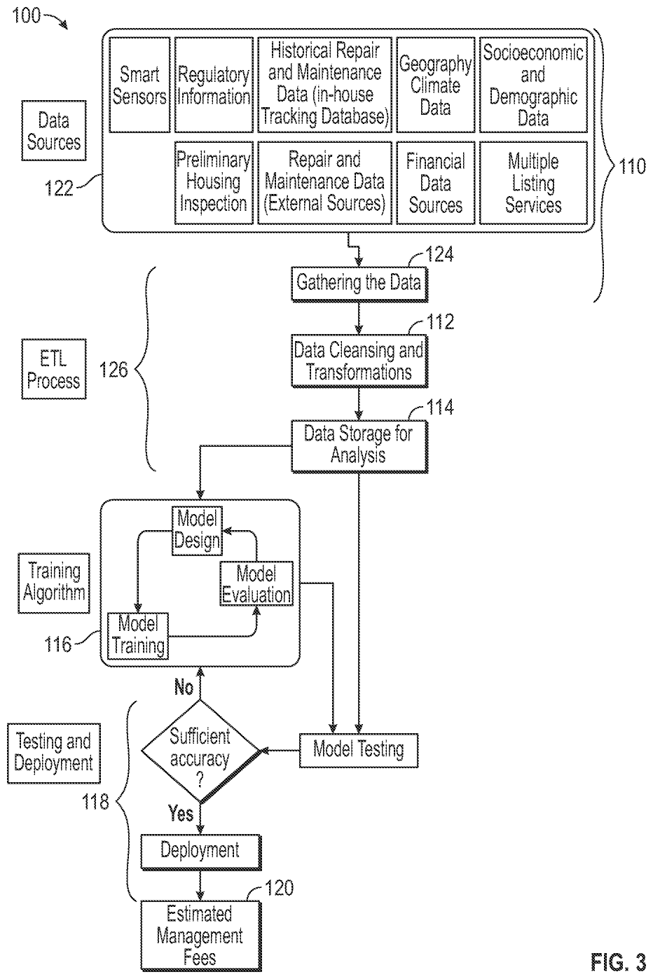

Referring to FIG. 3, an exemplary process 100 for predicting an appropriate property management flat fee is provided. As shown, this exemplary embodiment can be broken down into six stages (followed by their respective reference numerals):

Stage 1—Planning and Gathering Data (110)

Stage 2—Data Cleansing and Transformation (112)

Stage 3—Data Storage for Analysis (114)

Stage 4—Modeling and Training (116)

Stage 5—Testing and Deployment (118)

Stage 6—Predictions (120)

In Stage 1 (100) of this exemplary embodiment, before gathering and collecting data, a strategy is planned for identifying the appropriate data sources and creating the infrastructure needed to maintain and manage the data for a particular market. The strategy also includes the preparation of development processes and resources estimation, such as time, human, hardware and software requirements. After this has been accomplished, gathering and collecting the data can proceed. From this early phase of the process and until the deployment of the model, each stage should be adequately documented in order to achieve a complete understanding and control of the whole process. FIG. 3 shows some of the data sources 122 that may be used in the gathering step 124.

In Stage 2 (112), the data is transformed into a desired format(s). During this stage, inaccurate data records are detected and corrected. If not possible to repair, inaccurate data records should be removed. Handling data errors in the beginning of the process avoids possible mistakes during the next stages that could affect the final result. Furthermore, anomaly detection processes should be included in this phase. Identifying and handling outliers can be an important part of data cleansing process.

In Stage 3 (114), once the data has been collected and transformed, it is ready to be loaded into a database system. In some embodiments, the database stores and manages all the data in one place. Clear and efficient database management can facilitate the modeling process significantly. As part of creating the technology infrastructure, the database can play a major role of organizing the data before the modeling process. The performance and memory usage of the database processes should be considered when choosing a database system. In their initial systems, the patent applicants have chosen to work with an SQL server as a storage system based on the different data features it provides. In this exemplary embodiment depicted in FIG. 3, steps 124, 112 and 114 together are considered an extract, transform, load (ETL) process 126.

In Stage 4 (116), modeling and training is performed. Throughout the modeling phase of this embodiment, there is an iterative process of design-train-evaluate the model, as depicted in FIG. 3. That means the stored data is used to train a machine learning model that predicts a housing management fee. During this phase, the model performance improves in each iteration. The training stage should be constantly monitored and evaluated. Each feature from the data set receives an estimated score from the model that reflects its impact on the management housing fee.

In Stage 5 (118), testing and deployment is performed. After the training process has been completed, the model is tested with new data, known as a test set. In other words, the test set consists of data that was not considered during the training stage. This new data can come from properties that have already been under contract for a long time and their optimal management fee is known. If the model generates a good prediction score of the optimal management fee, it is ready for deployment.

In Stage 6 (120), once the model has been deployed and running in a production environment, a property management company can use it to optimize its pricing policy and eventually the level of profitability. Using the most recent data from data sources 122, the model can be constantly updated to provide the most accurate pricing.

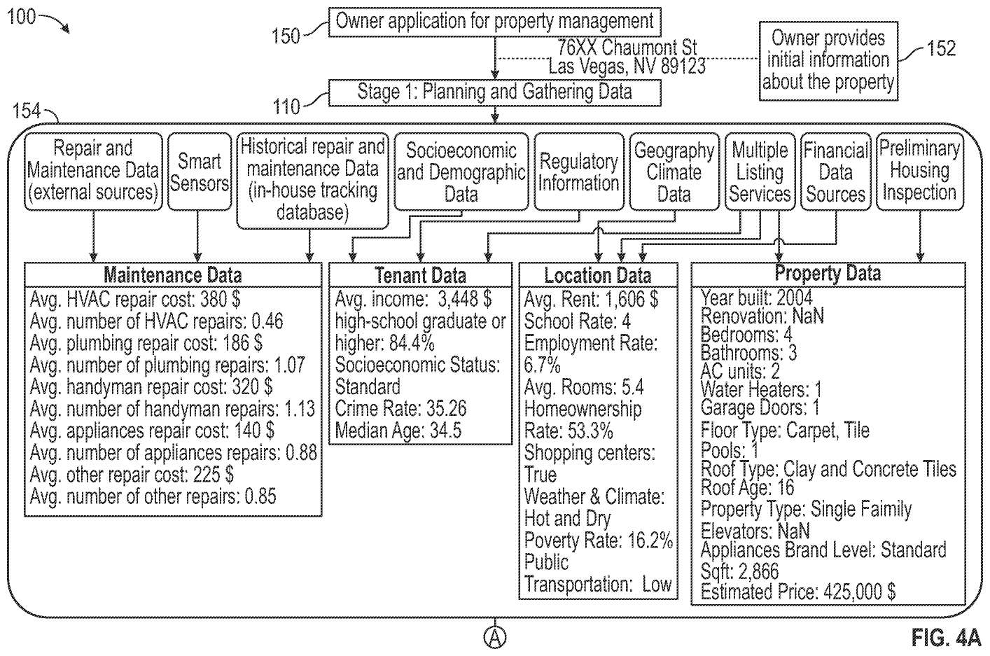

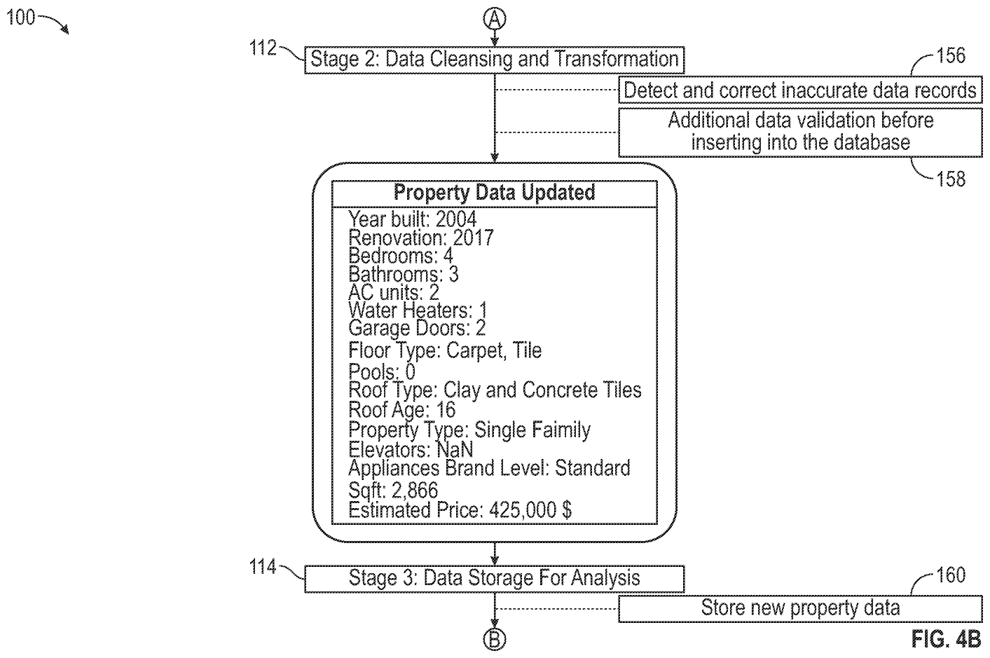

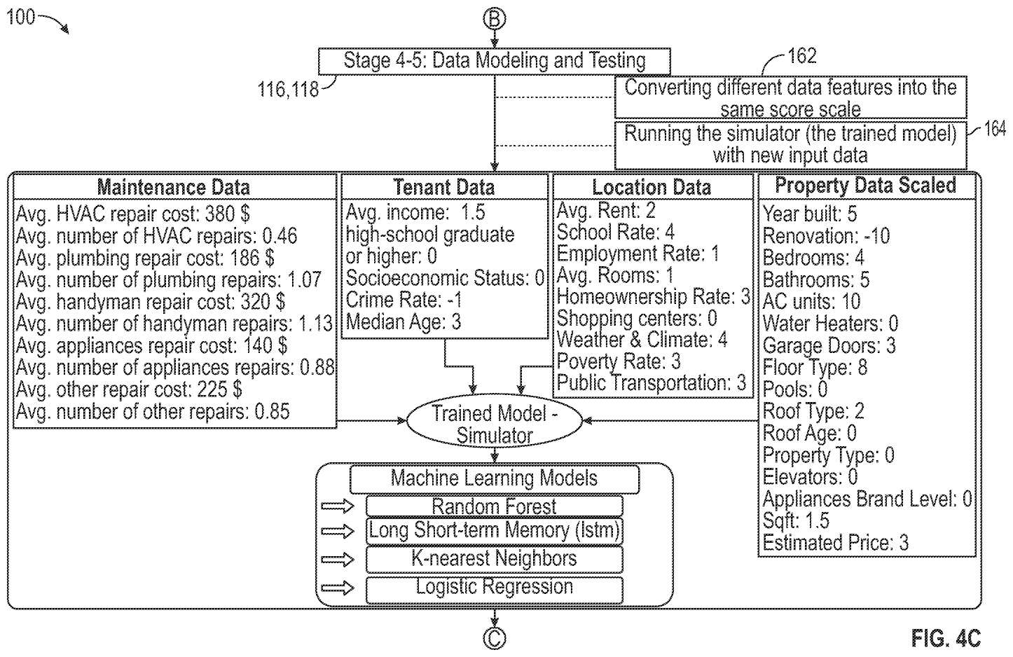

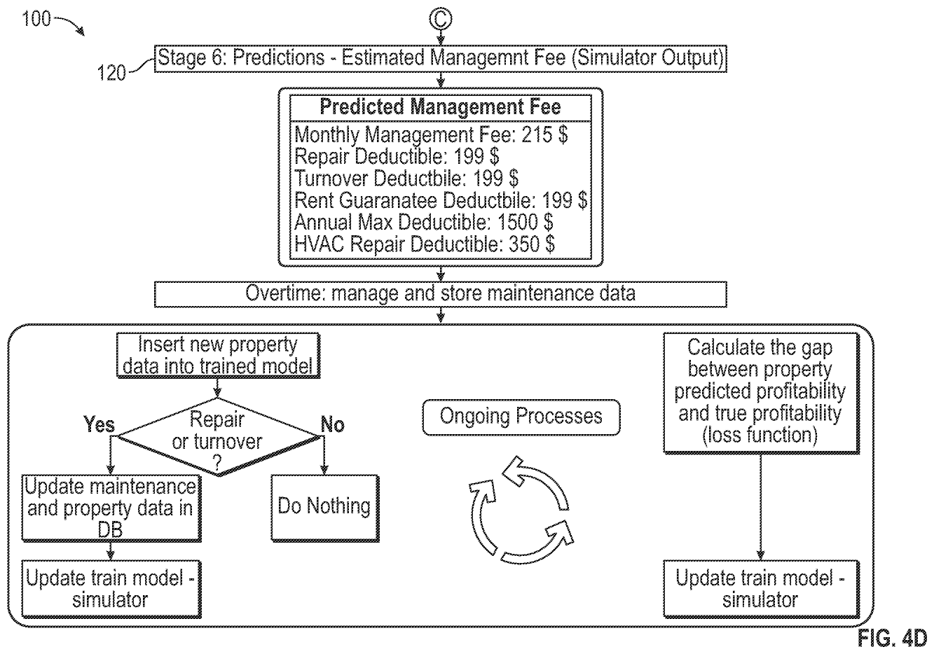

Referring to FIGS. 4A-4D, a general use case of exemplary process 100 described above in reference to FIG. 3 is provided to illustrate further details of the process. This example uses actual data from a property in Las Vegas, Nev., and illustrates the general flow of process 100, from the application for a property management service to an optimal pricing policy for the new property.

Referring to FIG. 4A, exemplary process 100 begins with a property owner submitting an application for property management in step 150. This includes the owner providing initial information 152 about the specific property. Once the property owner has submitted the application, system 100 gathers the relevant data from various sources as depicted in step 154. In this example, the data includes historical data previously developed and managed over time by the property management company.

Referring to FIG. 4B, Stage 2: Data Cleansing and Transformation is shown. Before inserting the data into the database, in step 156 system 100 ensures that all values are correct. During this stage, a second validation process 158 may be triggered as shown. In Stage 3: Data Storage for Analysis, new property data is stored in step 160. Storing and managing the data in a clear and efficient database is not only useful for use in a training model, but also for any future data analysis. This step can have a great influence on the data-driven decision making process.

Referring to FIG. 4C, Stages 4 and 5: Data Modeling and Testing are depicted. In step 162, the various data features are converted into the same score scale. This can be seen by comparing, for example, the scaled property data listed in FIG. 4C with the updated property data in FIG. 4B. In this example the model has already been deployed, so the new property data is used as input data to the trained model (along with the relevant location data, tenant data and maintenance data.) The simulator is then run in step 164. When the model was previously trained, multiple machine learning models or algorithms may have been used. Each may have an associated weight that determines its respective influence on the final result, based on the previous performance of each machine learning model or algorithm. For example, a random forest supervised learning algorithm, a long short-term memory recurrent network, a k-nearest neighbors algorithm, a logistic regression algorithm and or other models or algorithms may be used.

Referring to FIG. 4D, Stage 6: Predictions is shown. In this exemplary embodiment, the output of system 100 includes a predicted monthly management fee (e.g., $215) that will cover all property management services, maintenance, repairs and vacancies. The output also includes deductible amounts to be paid by the property owner. This can include deductibles that are paid whenever there is a repair, tenant turnover, a vacancy or a heating, ventilation and air conditioning (HVAC) repair, and can include an annual maximum deductible.

FIG. 4D also depicts an additional Overtime Stage that can occur after the model provides the above predictions. In this stage, the databases and models are maintained and updated. For example, whenever a repair or tenant turnover occurs on a property that has been run through the trained model, updates are made to the maintenance and property data in the database(s), and updates are made to the trained model or simulator. Another ongoing process that may be performed is calculating the gap between the predicted profitability for a property that has been run through the trained model with the actual profitability. These gaps, or gaps above a predetermined threshold, can be used to further train the model or simulator.

Various alternatives, modifications, and equivalents may be used in lieu of the above components. Additionally, the techniques described here may be implemented in hardware or software, or a combination of the two. The techniques may be implemented in computer programs executing on programmable computers that each includes a processor, a storage medium readable by the processor (including volatile and nonvolatile memory and/or storage elements), and suitable input and output devices. Program code may be applied to data entered using an input device to perform the functions described and to generate output information. The output information may be applied to one or more output devices.

Each program may be implemented in a high-level procedural or object-oriented programming language to operate in conjunction with a computer system. However, the programs may be implemented in assembly or machine language, if desired. In any case, the language may be a compiled or interpreted language.

Each such computer program can be stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

Thus, any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control or perform any of the steps, including but not limited to: displaying, communicating with the user, analyzing, modifying parameters (including timing, frequency, intensity, etc.), determining, alerting, or the like.

While exemplary embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the disclosure. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present disclosure.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and/or methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims. When a feature is described as optional, that does not necessarily mean that other features not described as optional are required.

The examples and illustrations included herein show, by way of illustration and not of limitation, specific embodiments in which the subject matter may be practiced. As mentioned, other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of automatically providing property-specific pricing for property management services, the method comprising the steps of:
gathering data;
cleansing and transforming the data;
storing the data for analysis;
inputting the stored data into a modeling and training process to arrive at a preliminary price for providing property management services for a specific property; and
testing the preliminary price to arrive at a final vetted price for providing property management services for the specific property.

2. The method of claim 1, wherein the gathered data comprises multiple parameters gathered from at least four different data types.

3. The method of claim 2, wherein the at least four different data types comprise property, maintenance, tenant and location.

4. The method of claim 3, wherein at least one of the parameters is gathered from each of the at least four different data types.

5. The method of claim 3, wherein at least three of the parameters are gathered from each of the at least four different data types.

6. The method of claim 3, wherein at least five of the parameters are gathered from each of the at least four different data types.

7. The method of claim 1, wherein the gathered data comprises data received from a plurality of smart sensors.

8. The method of claim 7, wherein at least one of the smart sensors is located on the specific property.

9. The method of claim 1, wherein the modeling and training process comprises multiple iterations of designing, training and evaluating a model.

10. The method of claim 1, wherein the modeling and training process comprises training a machine learning model.

11. The method of claim 10, wherein the machine learning model comprises a random forest supervised learning algorithm.

12. The method of claim 10, wherein the machine learning model comprises a long short-term memory recurrent network.

13. The method of claim 10, wherein the machine learning model comprises a k-nearest neighbors algorithm.

14. The method of claim 10, wherein the machine learning model comprises a logistic regression algorithm.

15. The method of claim 1, wherein the modeling and training process comprises training a model with a plurality of machine learning models that each have an assigned weight, wherein the assigned weights determine the associated model's relative influence on the preliminary price.

16. The method of claim 15, wherein the assigned weight for each machine learning model is based on previous performance of the associated model.

17. The method of claim 1, wherein the testing step comprises running a model developed during the modeling and training process with new data that was not used to train the model.

18. The method of claim 1, wherein during the modeling and training process a required profit rate for a property management company is considered.

19. A non-transitory computing device readable medium having instructions stored thereon for automatically providing property-specific pricing for property management services, wherein the instructions are executable by a processor to cause a computing device to:
gather data in the computing device;
cleanse and transform the data in the computing device;
store the data, in the computing device, for analysis;
input the stored data into a modeling and training process, in the computing device, to arrive at a preliminary price for providing property management services for a specific property; and
test, in the computing device, the preliminary price to arrive at a final vetted price for providing property management services for the specific property.
